(19) United States
(12) Patent Application Publication
(10) Pub. No.: US 2019/0203650 A1
(43) Pub. Date: Jul. 4, 2019

(54) VARIABLE STROKE INTERNAL COMBUSTION ENGINE WITH VARIABLE AIRFLOW AND COMPRESSION RATIO

(71) Applicant: YAN ENGINES, INC., Austin, TX (US)

(72) Inventors: Hailuat D. Yan, Austin, TX (US); Ryan Wostarek, Austin, TX (US); Miin Jeng Yan, Austin, TX (US)

(73) Assignee: YAN ENGINES, INC., Austin, TX (US)

(21) Appl. No.: 16/217,592

(22) Filed: Dec. 12, 2018

Related U.S. Application Data
(60) Provisional application No. 62/613,230, filed on Jan. 3, 2018.

(51) Int. Cl. F02D 13/02; F02D 15/02; F02B 75/04

(52) U.S. Cl. CPC F02D 13/0207; F02D 15/02; F02D 2200/024; F02D 2200/023; F02B 75/044

(57) ABSTRACT

An internal combustion engine that includes a variable stroke piston is described. The described engine includes a variable valve timing system and optional variable compression ration system. In embodiments, an electronic control unit coordinates the operations of the variable stroke piston, variable valve timing system, and variable compression ratio system in order to optimize engine performance across a wide range of engine conditions.

### CROSS REFERENCE TO RELATED APPLICATIONS

This application is claims priority to U.S. Provisional Application No. 62/613,230, filed Jan. 3, 2018, the disclosure of which is incorporated herein by reference.

### FIELD

Embodiments described herein relate to internal combustion engines equipped with a variable stroke piston and variable valve timing systems arranged to improve engine efficiency. More particularly, embodiments relate to apparatus and methods for enhancing the performance and efficiency of piston internal combustion engines equipped with a variable or differential stroke piston using variable valve timing and/or a variable compression ratio system.

### BACKGROUND AND SUMMARY

In an internal combustion engine the expansion of the high-temperature and high-pressure gases produced by combustion apply direct force to some component of the engine, typically a piston. This force moves the component over a distance, transforming chemical energy into useful mechanical energy.

Conventional internal combustion engines have at least one cylinder, a piston in the cylinder, and a crank shaft driven by the piston. Most of these engines operate on a four stroke cycle of the piston per two revolutions of the crankshaft. During the cycle, the piston's strokes are first outward for intake, first inward for compression, second outward (after ignition) for combustion and power, and second inward for exhaust. The burnt gas is driven out during the exhaust stroke and a fresh charge is drawn in during the intake stroke. These two strokes require little force and the piston is subject to low pressures. These two strokes also traditionally require one entire revolution of the crankshaft for these purposes. More output could be obtained from a four stroke engine of a given displacement if it could complete its cycle in only one revolution of the crankshaft. There are conventional two-stroke engines in which the combustion cycle is completed in two strokes where gasses are exchanged by uncovering intake and exhaust ports in the lower end of the cylinder, thereby eliminating the intake and exhaust strokes of the piston. Such two-stroke engines generally weigh less than four-stroke engines but are generally higher in emissions than four-stroke engines, and hence are subjugated by regulation to certain special fields, such as small garden engines.

A differential-stroke internal combustion engine is disclosed in U.S. Pat. No. 5,243,938, which is incorporated herein by reference in its entirety. In the differential-stroke engine, the piston completes four separate strokes—intake, compression, power, and exhaust—during one crankshaft revolution.

U.S. Pat. No. 5,243,938 discloses a differential four-stroke inner piston part and an outer piston part that is connected by a connecting rod to a crankshaft during the whole cycle. The two piston parts combine to ride on the connecting rod during the power and compression portions of the cycle, when compression forces are at their highest levels. Various apparatus may be used to operate the inner piston part, such as the single cam system described in U.S. Pat. No. 5,243,938, the cam-switching system described in U.S. Pat. No. 8,876,674 or the electronically actuated system described in U.S. Pat. No. 9,366,179, all of which are incorporated herein by reference in their entirety.

A piston-train guide apparatus is disclosed in U.S. Pat. No. 8,851,031, which is incorporated herein by reference in its entirety. U.S. Pat. No. 8,851,031 discloses a differential stroke reciprocating internal combustion engine having an engine shaft and a piston configured to reciprocate within a cylinder chamber comprising an inner piston part, a piston stem coupled at a first end to said inner piston part, an outer piston part which serves as a carrier for said inner piston part and is connected to said engine shaft, wherein said inner piston part is configured to operate on a cycle different from that of said outer piston part and a control and linkage assembly coupled to said engine at an anchor point, and said control and linkage assembly pivotally coupled at a second end of said piston stem defining a copy point, wherein said control and linkage assembly guides and defines the movement of said copy point to be substantially aligned with an axis of said cylinder chamber.

An actuator with a plurality of cams for a variable stroke cycle engine is disclosed in U.S. Pat. No. 8,875,674, which is incorporated herein by reference in its entirety. U.S. Pat. No. 8,875,674 discloses an actuator apparatus including a piston-lever element coupled to an inner or second piston part of a differential stroke combustion engine and a plurality of cam-follower assemblies which are selectively coupleable with the piston-lever element for controlling operation of the second piston part, wherein selective engagement and disengagement of one or more of the cam-follower assemblies defines an operational mode of the second piston part.

A linear actuator for a variable stroke cycle engine is disclosed in U.S. Pat. No. 9,366,179, which is incorporated herein by reference in its entirety. U.S. Pat. No. 9,366,179 discloses a variable-stroke reciprocating internal combustion engine, the engine having an engine shaft and a piston configured to reciprocate within a cylinder chamber having an axis, each piston having a first piston part operable to move in unison with, or separately from, a second piston part to define piston strokes for different thermal functions of the engine, the engine including an assembly pivotally coupled to the first piston part at a copy point and an actuator coupled to the assembly, wherein the actuator is operable to control motion of the assembly to thereby define substantially linear movement of the copy point along the cylinder chamber axis.

Variable Valve Timing (VVT) is the process of altering the timing of opening and closing engine intake or exhaust valves relative to the position of the crankshaft. VVT can be used to alter engine performance, fuel economy, and/or exhaust emissions. Variable Valve Lift (VVL) may be used alone or in conjunction with VVT and is the process of altering the distance a valve is opened. VVT systems may additionally incorporate VVL systems and be used to allow more or less air or exhaust to pass through the opened valve in a given duration.

The intake and exhaust valves of an internal combustion engine are used to control the flow of intake and exhaust gasses into and out of the combustion chamber. The flow of these gasses may be controlled by varying the timing, duration, and lift of each valve. Additionally, many modern engine combustion chambers utilize multiple intake and/or exhaust valves in a single combustion chamber. In some configurations, the timing, duration, and lift of a single valve of a set may be altered in order to create the desired gas flow. Traditional engines, which lacked the VVT and/or VVL systems were operationally constrained as the valve timing and lift were constant at all engine loads. This constrained arrangement results in engine inefficiencies through many different engine speeds and loads. When operating at high speeds, or under high load, an engine requires a large amount of air in order to fully combust a large amount of fuel. If an intake valve is closed before a sufficient amount of air has entered the combustion chamber, engine output will be reduced. Fixed valve timing and duration could be optimized for performance when the engine is under a high load, but this will cause inefficiencies when the engine is operating at low loads. If the intake valve is opened while the exhaust valve is still open following combustion, exhaust gases and unburnt fuel may exit the engine, leading to lower engine performance and potentially harmful emissions.

Traditional VVT systems used cam phasing, in which the phase angle of the cam shaft is rotationally adjusted forwards or backwards relative to the position of the crankshaft. This system caused the valves to open earlier or later with respect to the crankshaft but did not adjust the duration or lift of the valves. Adjusting the duration and lift of valves may be performed using multiple cam profiles and selecting between the profiles under various conditions. Internal combustion engines traditionally operate intake and exhaust valves using cam shafts although hydraulic, electronic, and pneumatic actuators may be used and may be arranged to provide a high degree of control of the timing, duration, and lift of intake and/or exhaust valves.

One performance variable in internal combustion engines is the compression ratio. The mechanical compression ratio is generally the ratio of the internal volume of combustion chamber at its largest volume to its smallest volume. The combustion chamber is typically at its largest volume when the piston is withdrawn, at the end of the intake stroke for example. The combustion chamber is typically at its smallest volume when the piston is raised and the fuel/air mixture is compressed, for example at combustion. If the compression ratio is too high, the fuel/air mixture may combust early leading to engine knocking (premature combustion) and potentially damaging the engine. If the compression ratio is too low, the engine will lose efficiency.

Engines burn fuel most efficiently when operating at the point of full power. This is because the engine is operating at wide open throttle or the maximum air flow possible for a given engine. This creates the highest compression ratio, the optimal air/fuel mixture, and the lowest percentage of cyclical losses (caused by friction and pumping) when compared to the output of the engine. Operating at a high compression ratios is generally seen as positive because the high compression results in a more volatile charge of air and fuel and a more complete combustion.

When an engine operates at less than full power, the throttle is typically less open or air flow is otherwise restricted (possibly by VVT) and less air fills the cylinder. Operating an engine at less than full power can also lead to a reduced effective compression ratio (eCR). When air flow into the cylinder is restricted but the piston continues to travel downward a vacuum may be created. The full piston stroke length may create a 10:1 mechanical compression ratio, but if the air intake valve is closed early or air flow is otherwise restricted so that the cylinder is only half filled with air and creates a vacuum as the piston is lowered, the effective compression ratio may only be 5:1. This leads to a loss of volumetric efficiency, pumping losses and reduced effective compression ratio. Pumping losses are created with the piston is being withdrawn from the cylinder but airflow into the cylinder is restricted, creating a vacuum effect in the cylinder which requires more energy to overcome. It should be noted while the discussion of pumping losses and focuses on the timing of intake valves, similar concerns impact the engines ability to clear exhaust gasses from the cylinder as well.

Variable Compression ratio (VCR) systems have been designed which adjust the compression ratio of an engine in order to increase engine performance at both high and low loads. Current VCR engines generally operate by adjusting the position of the piston within the combustion cylinder, thereby adjusting the final volume of the cylinder at top dead center (TDC) of the compression stroke in order to adjust the eCR. Existing VCR systems adjust the position of the piston with respect to the cylinder rather than adjusting the stroke of the piston.

What is needed is an internal combustion engine which combines the aforementioned technologies to allow control of the intake and exhaust valve timing, duration and/or lift in combination with variable control of the piston stroke in order to adjust the volume of the cylinder based on the volume of air required under current engine operating conditions, also potentially in combination with a variable compression ratio system so that the optimized volume of air can be compressed to an optimal compression ratio. This would allow for an internal combustion engine that has maximized volumetric efficiency, minimized cyclical losses in friction and pumping, and idealized compression ratio, all contributing to an engine that has potentially no throttle body required, a combustion cycle matched to output demand, higher overall power density and maximum fuel engine efficiency through a broad range of engine loads and conditions.

### BRIEF DESCRIPTION OF THE DRAWINGS

FIG. 1 shows a cross-section view normal to the axis of rotation of the crankshaft of a variable stroke engine.

FIG. 2 depicts one embodiment of a control and guide apparatus used in a variable stroke engine.

FIG. 3 generally describes the operation of two-stage variable piston stroke systems, two-stage VVT systems, and two-stage VCR systems.

FIG. 4 shows one potential process flow associated with a fully coordinated two-stage system of systems.

FIG. 5 generally describes the position of the inner and outer piston parts on a variable piston stroke system with coordinated valve timing in a VVT system, in relation to a crank angle under high and low load operations.

FIG. 6 depicts one possible process flow of an embodiment which utilizes a continuously variable piston, continuously variable valve train VVT, and a continuously variable VCR.

FIG. 7 depicts the motion of one embodiment of the system described in FIG. 6 in relation to the rotation of the crankshaft.

### DETAILED DESCRIPTION

The aspects, features, and advantages of one or more embodiments mentioned herein are described in more detail by reference to the drawings, wherein like reference numerals represent like elements. Certain embodiments disclosed herein provide a variable piston stroke (VPS) internal combustion engine, a variable valve timing (VVT) system, a variable compression ratio (VCR) system, and/or an electronic control unit (ECU), wherein the ECU coordinates the operation of the variable stroke piston in conjunction with the VVT system and VCR system in order to maintain an optimized fuel efficiency and/or engine performance.

Certain embodiments may be beneficial for the real-time and continuous optimization of the four engine strokes, in displacements and periods, during engine operations for fuel efficiency, power, and emissions. The ability to create piston strokes that can be varied by stroke duration, length, height, lift and seating events, and period of the inner piston provides greater flexibility to fine tune the engine design in order to match engine output with power demand, obtain a more efficient combustion cycle, higher power density, lower cyclical losses, greater overall engine efficiency, and lower levels of pollution emissions.

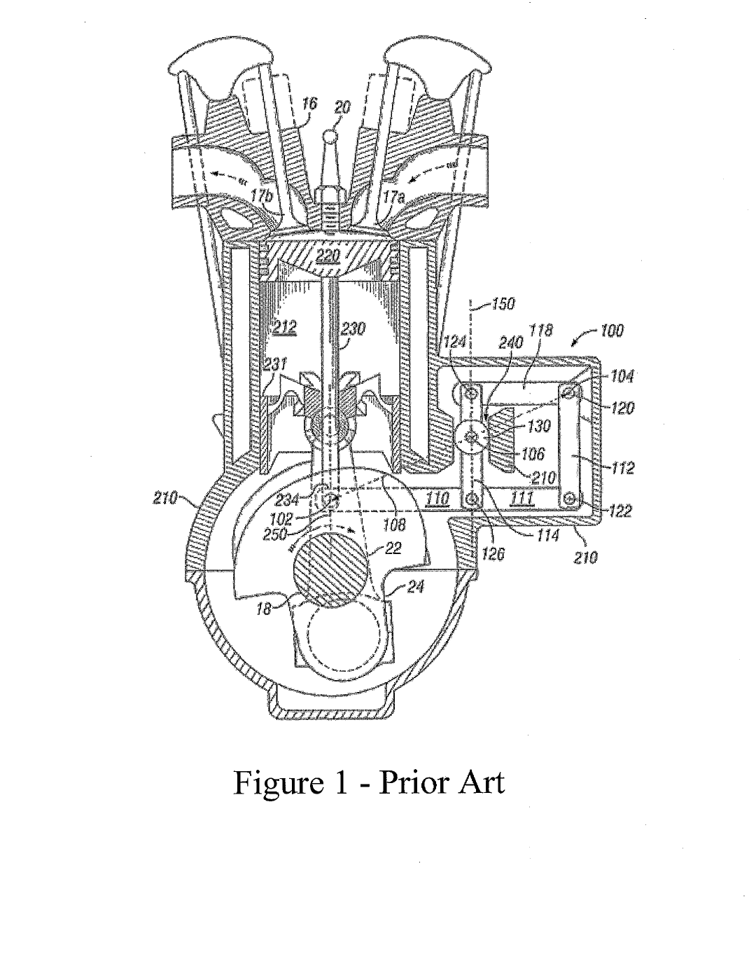

Referring to FIG. 1, a cross-section view normal to the axis of rotation of the crankshaft of a variable stroke engine is shown. The particular embodiment shown in FIG. 1 includes a control and guide apparatus 100 incorporated therein in accordance with certain embodiments of the present disclosure is shown. A variable stroke piston moves within the fixed cylinder 212 between a fixed cylinder head 16 above and a rotating crankshaft 18 below, referring to the orientation of the engine shown in FIG. 1. Charging and exhausting cylinder 212 is controlled by intake valve 17a and exhaust valve 17b respectively. Combustion is initiated by a spark plug 20 (not used in diesel applications) in cylinder head 16. Engine 210 is operable to complete one full combustion cycle per engine revolution.

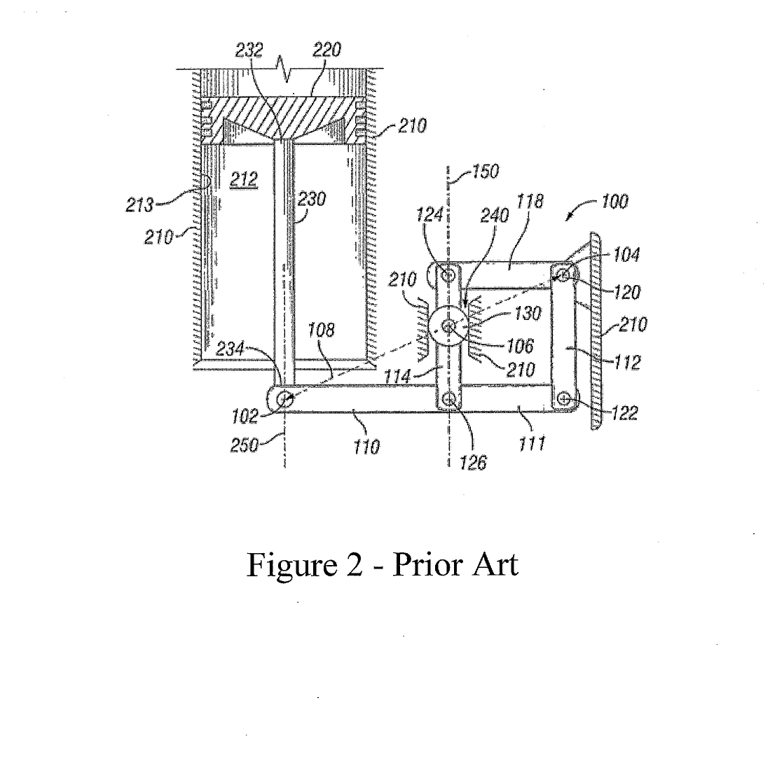

The variable stroke piston has an inner piston part 220 which closes and seals the combustion chamber and an outer piston part 231 which is connected by a connecting rod 22 to the crankshaft 18 and also serves as a carrier for the inner piston part 220 during portions of its cycle. Embodiments disclosed herein provide for the inner piston part 220 to operate on four strokes per cycle and the outer piston part 231 to operate on two strokes per cycle. During the exhaust and the intake portions of the cycle, the inner piston part 220 and outer piston part 231 separate. During separation, inner piston part 220 may be actuated and driven by the control and guide apparatus 100 described in FIG. 2. As shown, in certain embodiments, the guide apparatus 100 may be located outside of the cylinder and cylinder bore 212 and positioned away from the movements of the piston parts and engine shaft. Meanwhile, the outer piston part 231 continues to move under control of crank arm 24 and connecting rod 22.

In certain embodiments, an actuator (e.g., a robotic arm device) operable independent of the engine shaft (e.g., crankshaft) may be provided to define or optimize the stroke length and timing of the piston strokes during different thermal functions of the engine and adapt the optimal piston stroke combinations to changing loading conditions during engine operations. The actuator may be synchronized with other engine components, such as an associated cam-driven valve train or other valve train systems that have no cams and are operated by electronics or systems that combine both electronic and cam-driven systems. The actuator and other engine components may be controlled and optimized by an engine electronic control unit. In certain embodiments, the actuator may be a linear actuator. In particular embodiments, the actuator may comprise an electromechanical actuator, or any device which carries out electrical operations by using moving parts, or actuator tongue that moves in a substantially linear direction. The electromechanical actuator may be controlled by an engine electronic control unit. In other embodiments, the actuator may be controlled by hydraulic, mechanical, or electromechanical systems or components. Many embodiments utilize an actuator to control movement of the inner piston part of a variable piston stroke engine however the inner piston part may be cam driven as well. Switching between multiple piston cams which drive the inner piston part creates multiple engine operation profiles which may be tailored for various engine operating requirements. In particular a high load and low load cam may be utilized to optimize the timing and displacement of the inner piston part. It will be appreciated that more than two distinct cam profiles may be utilized in order to more finely tune the operations of the inner piston part and thus engine operations.

Actuator driven and cam driven differential stroke pistons may be configured to be continuously variable. A variable stroke piston may allow for a high degree of control as the timing, stroke length, and resulting displacement of each piston stroke may be catered for the precise engine conditions at that time. Actuator driven and cam driven variable stroke pistons may utilize, but do not necessarily require, assembly and/or control guides similar to the embodiment shown in FIG. 2.

Actuator driven and/or continuously variable stroke piston embodiments may require a higher degree of mechanical and/or electrical control as compared to two-stage or multi-stage cam-driven differential stroke pistons but allow for a greater degree of control and/or optimization. Each of these systems offers a high degree of value and each may be suitable under certain operating conditions and depending on various manufacturing, financial, durability, regulatory, and other factors.

Embodiments of the disclosed engine include a plurality of sensors to measure and/or determine, directly and/or indirectly, the engine load and other engine operating parameters. These parameters include, for example, the position and rotational speed of the crankshaft and/or cam shafts; the temperatures of various engine components; the temperature of gasses and fluids in and/or around the engine including the temperature of engine cooling fluids such as cooling water, the temperature of air entering the intake valve, the temperature of exhaust gasses exiting the exhaust valve, the temperature of gasses within the combustion chamber at various times in the engine cycle, and/or the ambient atmospheric temperature; the pressure of various gasses and fluids in and around the engine including the pressure of air entering the intake valve, the pressure of exhaust gasses exiting the exhaust valve, the pressure of gasses within the combustion chamber at various times in the engine cycle, and/or the ambient atmospheric pressure as well as the mass airflow, fuel flow, chemical composition of the intake and exhaust gasses, output of a knock sensor, power demand, and other engine parameters.

In embodiments of the disclosed engine, an electronic control unit (ECU) operably connected to a plurality of sensors acquires sensor data in order to adjust engine operations, parameters, and performance. In many disclosed embodiments, the electronic control unit is configured to determine the optimum intake depth and/or displacement of the inner piston part 220 and adjust the timing and stroke length accordingly to achieve the required or optimized load or energy output. The electronic control unit is similarly configured to determine the optimum timing, duration, and lift of the intake valves 17a and exhaust valves 17b in order to optimize engine performance for power, efficiency, and/or emissions and adjust engine operations accordingly.

Embodiments of the disclosed internal combustion engine include a variable valve timing (VVT) system. The disclosed variable valve timing systems may be cam operated or use a cam-less valve train. VVT systems may operate as discrete stage, commonly two-stage systems which may be generally tailored for high load or low load operations, or may be designed as continuously variable systems which may be adjusted according to specific engine conditions.

Cam operated VVT systems typically include at least a first cam and a second cam and a control unit to switch between them. The lobes of a cam are tied, through the valve train to intake valves 17a and/or exhaust valves 17b. The profiles of the cam controls the timing, duration and lift of the corresponding valve. The profiles of the first cam and second cam are distinct relative to each other such that, for example, the first cam profile may allow the engine to perform more optimally under high engine loads while the second cam may allow the engine to perform more optimally under lower engine loads. The electronic control unit may activate a cam switching unit when the ECU determines from the analysis of sensor data that the engine would perform more optimally using the alternate cam.

Cam operated VVT systems may also include a phase angle controller which allows the cam to be rotated with respect to the crankshaft. Adjustment of a cam phase angel may adjust the timing of the opening and closing of the associated valves but will not, by itself, impact the duration or lift of the valve opening and closing. The electronic control unit may activate a phase angle controller when the ECU determines from analysis of the sensor data that the engine would perform more optimally under an adjusted cam phase angle and corresponding adjusted valve timing.

Some embodiments of the disclosed engine utilize a cam-less valve train in which the ECU activates actuators to control the timing, duration, and lift of the intake and exhaust valves. Such variable valve actuation apparatuses may be electrically, magnetically, pneumatically, and/or hydraulically powered and controlled directly by the ECU or by a separate controller operably connected to the ECU. A cam-less valve train allows for individual valves to be opened or closed independently of other engine components. This can allow a high degree of control of the timing, duration, and lift parameters of an individual valve.

For engine embodiments which utilize multiple intake and/or exhaust valves for a single cylinder, both multi-cam and cam-less valve trains may be used to operate a single valve in order to control air flow. In some embodiments, this arrangement may be used to shut down individual cylinders within an engine in order to improve engine performance.

Both cam-driven and cam-less VVT systems suffer from some limitations when incorporated into traditional engines with fixed piston timing and displacement. As discussed, when an intake valve is closed prior to the piston fully withdrawing on the intake stroke, a vacuum is created in the combustion cylinder. This vacuum reduces the effective compression ratio and leads to pumping losses and other engine inefficiencies. In an effort to reduce these inefficiencies, VVT systems are typically optimized for the average expected use of the engine drive cycle. The inefficiencies created by the use of a VVT system with a traditional engine are significantly, if not totally, addressed by the embodiments which utilize a combination of a VVT system with a variable stroke piston.

Certain embodiments of the disclose engine include a variable compression ratio (VCR) system. These types of system allow the final cylinder volume to be adjusted. When operating under low load, the engine may decrease the final combustion chamber volume. If the flow of intake air is not adjusted, this results in a higher compression ratio. If the flow of intake air is restricted, this combustion chamber volume adjustment can help to create less of a vacuum as the piston withdraws form the cylinder lessen inefficiencies while operating under low load conditions. In some embodiments, when the engine operates under high load conditions, the piston seat may be lowered, thereby increasing the final volume of the combustion chamber. This can allow a greater intake of air while lessening the resulting impact on compression ratio.

In some preferred embodiments, the disclosed piston internal combustion engine may be considered a system of systems. One aspect of the disclosed engine is the variable piston stroke engine which allows the stroke length and timing of the inner piston part 220 to function independently of the outer piston part 231 and the crankshaft 18. In many embodiments, the timing of the inner piston part 220 is at least somewhat adjustable independently of the outer piston part and crankshaft as well. The combination of the variable stroke piston with a variable valve timing system allows the engine to operate at near optimal conditions under a wide variety of conditions. Under low load conditions, the VVT system may restrict airflow by adjusting the timing, duration, and/or lift of the intake valves 17a in order to maintain the proper fuel/air ratio. In response to these conditions, the ECU can direct the inner piston part 220 to limit the distance traveled on the intake stroke, thereby creating an effective cylinder volume that is optimized for the amount of air drawn into the chamber. This allows the VPS and VVT systems to work in combination in order to effectively adjust the engine displacement in real time. The ECU may analyze sensor data in order to determine the ideal engine operations and instruct the VVT to intake a specific amount of air and instruct the variable stroke piston to optimize the stroke distance of the inner piston part in order to accommodate that specific amount of intake air. Similar adjustments may be made with respect to the exhaust stroke of the engine in order to optimize engine performance.

In addition to utilizing the combination of a variable stroke piston and a variable valve timing system, a variable compression system may also be used. The combination of these three systems allows for a greater total range of effective displacements to be created by the variable stroke engine. Under low load conditions, the VCR system may decrease the final cylinder volume, thereby allowing the inner piston part to create the smallest combustion cylinder volume possible for a given engine in order to efficiently make use of a small amount of air and fuel. Under high load conditions, a VCR system may increase the final cylinder volume, thereby allowing the inner piston part to create a larger maximum combustion cylinder volume for a given engine in order to efficiently use a large amount of air and fuel.

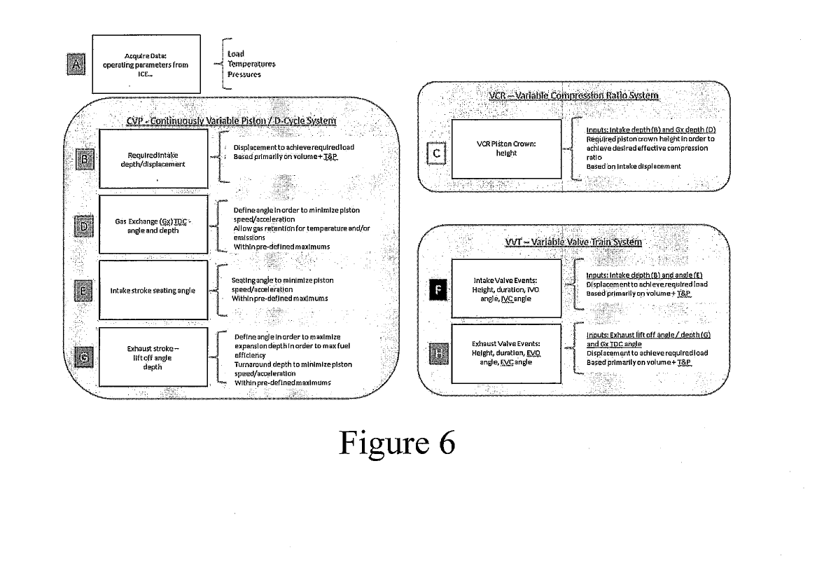

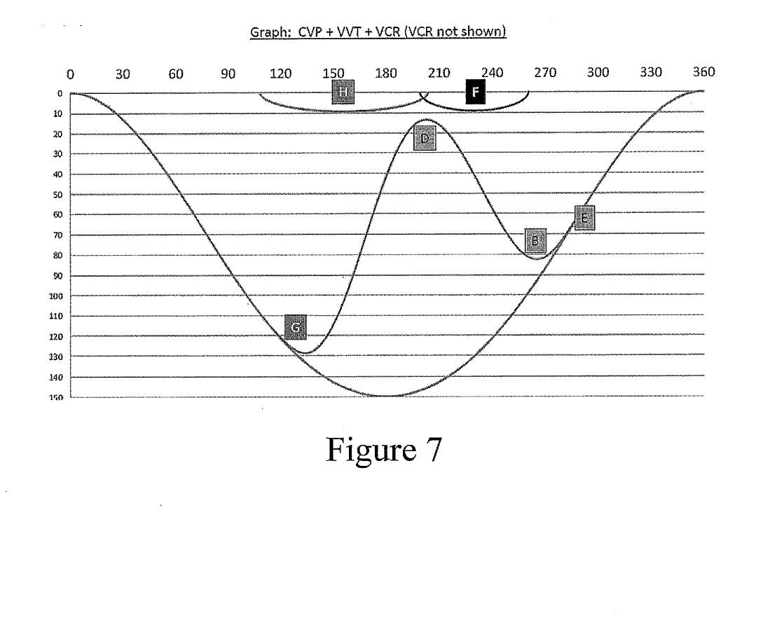

FIG. 6 depicts one possible process flow of an embodiment which utilizes a continuously variable piston, continuously variable valve train VVT, and a continuously variable VCR. FIG. 7 depicts the motion one embodiment of the continuously variable piston and continuously variable VVT in relation to the rotation of the crankshaft.

The combination of a variable stroke piston and a VVT system addresses the problem of volumetric inefficiency and reduced thermal efficiency, particularly during part-load conditions. The combination of variable stroke piston and VVT systems allows an electronic control unit, in response to sensor data, to adjust the volume of intake air in order to correspond to the desired power output without suffering significant losses in thermal efficiency. This combination requires a distinct electronic control unit which is operably connected to both the VVT system and the variable stroke piston system. In a certain embodiments, the modified ECU is designed to control the VVT system in response to engine demands and then to control piston motion in response to the VVT operation. By controlling the variable stroke piston in response to the VVT, engine inefficiencies commonly associated with VVT systems can be significantly reduced and in some cases substantially eliminated. While traditional VVT systems are able to increase engine efficiency to some degree, engines which utilize VVT systems are hindered by the fixed nature of piston timing and displacement. These limitations in traditional engines utilizing VVT systems may be corrected by incorporating the added capability provided by a variable stroke piston. As discussed, the restriction of air intake caused by the VVT system under low loads creates its own inefficiencies when incorporated into traditional fixed piston stroke engines. These limitations are only increased as VVT technology is used to more aggressively to alter airflow. The earlier an intake valve is closed, the greater the volumetric and thermal inefficiencies. These limitations associated with VVT systems have been previously unaddressed and are substantially cured by the use of a variable stroke engine in combination with VVT systems.

In particular embodiments, volumetric efficiency losses when an engine is throttled or once the intake valve 17a is closed may be eliminated. In such embodiments, the ECU is configured to adjust the variable piston stroke in order to stop the downward motion of the piston simultaneously or even shortly prior to the closing of the intake valve.

Other embodiments of the disclosed ECU are configured to adjust the VVT system and/or VCR system based on the operations of the VPS system in order to properly coordinate the two systems. Still other embodiments of the ECU adjust the VPS system, the VVT system, and/or the VCR system in response to analyzed sensor data rather than in response to the operations of the other systems.

Many embodiments of the disclosed ECU will be configured to monitor a plurality of engine performance parameters. Certain embodiments of the disclosed ECU are equipped with machine learning technologies which will allow the ECU to adjust the manner in which is controls the VVT system, VPS system, and/or VCR system over time. This will allow the ECU to adapt its control over various engine parameters over time. As the engine and its components wear over time, it is possible the initially ideal relationships between the multiple systems will change. Embodiments equipped with machine learning capability are able to monitor these variations in performance overtime and make fine-tuned adjustments in order to maintain optimum engine performance as the engine wears.

Certain embodiments of the disclosed variable stroke engine include cam-driven variable stroke pistons rather than actuator driven continuously variable pistons. Some of these embodiments utilize a simplified design in which a low load piston cam may be switched for a high load piston cam. This creates two separate piston operating profiles which may be independently designed for increased performance under two distinct sets of engine operating conditions. The low load piston cam profile is generally configured to cooperate with a low load VVT system. A low load piston cam causes a shorter stroke of the inner piston part on the intake stroke, thereby coordinating with the reduced duration that an associated intake valve 17a is opened when the engine is operating under low loads. Conversely, a high load piston cam causes a longer stroke of the inner piston part on the intake stroke, thereby coordinating with the increased duration that an associated intake valve 17a is opened when the engine is operating under high loads. The ECU may coordinate switching of the piston cams based on analyzed sensor data, based on the operations of the VVT systems, and/or based on the operations of a VCR system.

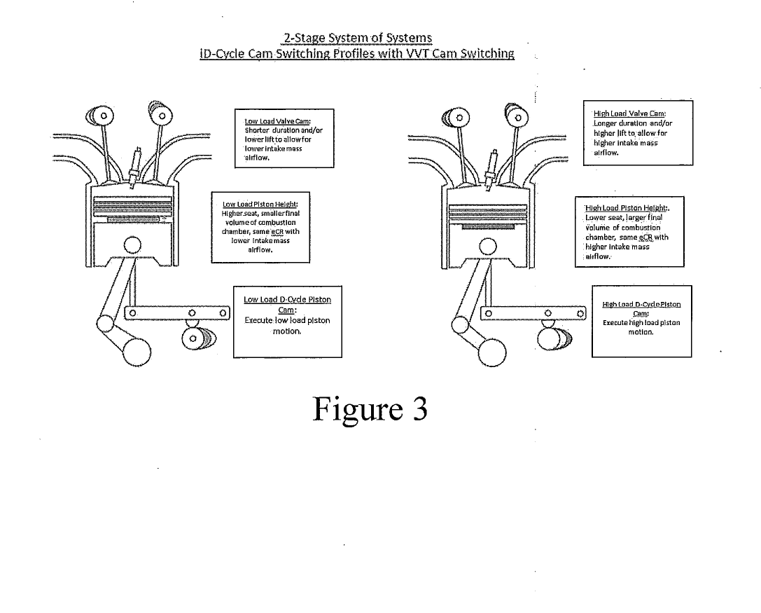

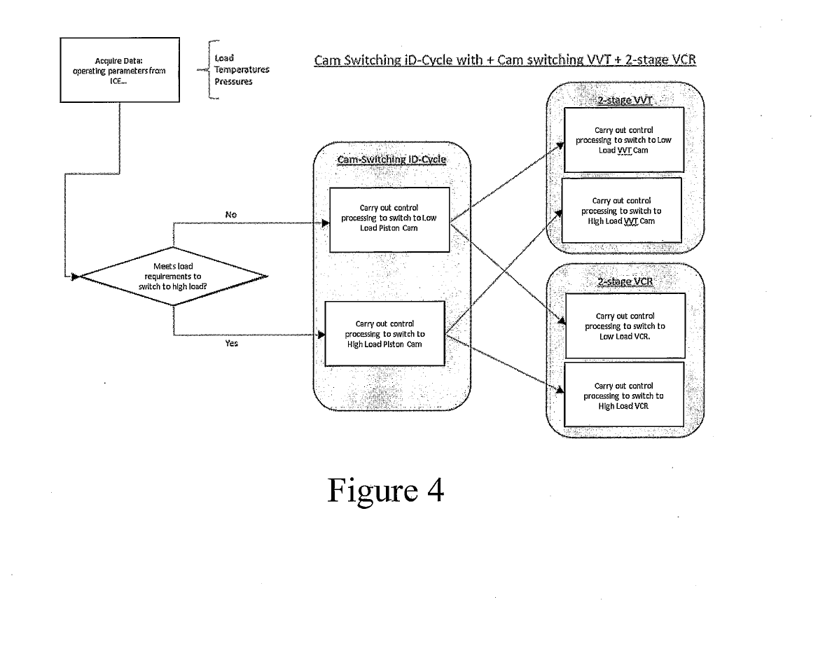

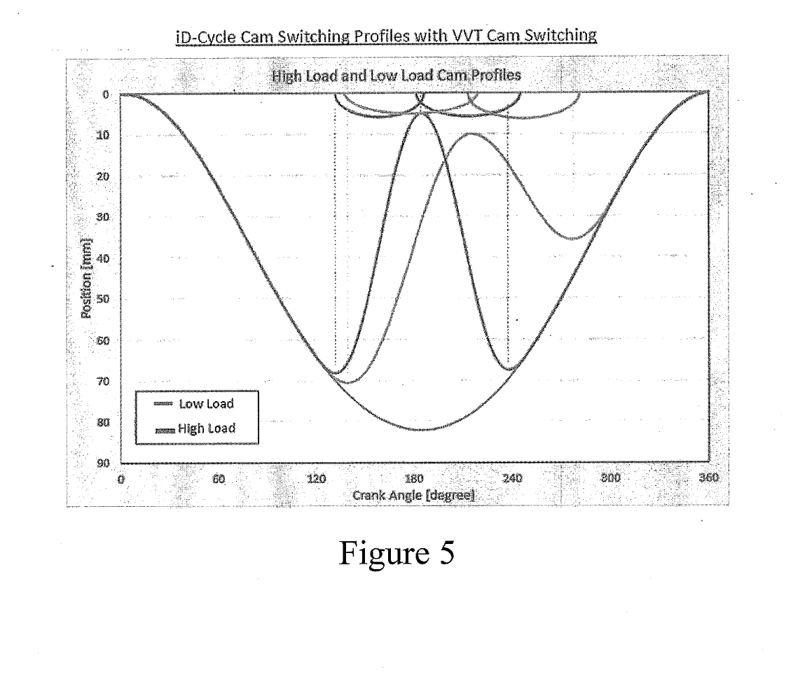

Some embodiments of the disclosed engine take advantage of a robust and simplified design by combining and/or coordinating a two-stage piston cam system, with a two-stage VVT system, and/or a two-stage VCR system. Some of these embodiments may be designed to switch the piston cam, VVT, and/or VCR systems into high load or low load operating modes simultaneously. Alternative embodiments may be designed to independently determine which of the piston-cam, VVT, and/or VCR systems should be activated in either the high load or low load conditions in order to create more optimal total engine performance for power, efficiency, and/or emissions. FIG. 3 generally describes the operation of two-stage piston cam systems, two-stage VVT systems, and two-stage VCR systems. FIG. 4 shows one potential process flow associated with a fully coordinated two-stage system of systems. FIG. 5 generally describes the position of the inner piston part in relation to the crank angle under high load and low load operations.

Certain embodiments of the disclosed engine eliminate the need for a throttle body. The disclosed combination of VVT and variable stroke piston systems acting in concert allow for a high degree of control of intake air. As such there is less, and in some cases no, need for the traditional throttle body. The use of a throttle body inherently limits potential airflow even when the throttle is wide open. Embodiments that eliminate the throttle body entirely have a larger potential for drawing intake air without restriction than engines which depend on a throttle body to regulate airflow.

Certain embodiments of the disclose engine may be utilized for autonomous or connected vehicles. For many autonomous or connected vehicles, the car's on-board computer determines or analyzes the vehicle's speed, acceleration, road conditions, and/or other conditions which relate to the engine output. Given this data, the ECU is able to effectively determine optimal engine operating parameters and may control a variable stroke piston, VVT, and VCR system based on the desired engine output.

In certain embodiments and under certain circumstances, multiple vehicles are networked together and exchange information with each other. Under these circumstances, a group of networked vehicles may all drive at a given speed depending on the driving conditions, including but not limited to, highway or city driving, traffic density, road surface, and/or weather conditions. Upon receiving data from networked vehicles, certain embodiments of the ECU are able to determine optimal engine operating parameters and may adjust the variable stroke piston, VVT, and VCR systems in order to best take advantage of the information received from networked vehicles.

Disclosed embodiments relate to an internal combustion engine comprising a variable stroke piston apparatus, wherein the variable stroke piston apparatus comprises a variable stroke piston effective for reciprocal operation in an engine cylinder chamber, an inner piston part which closes and seals the cylinder chamber and an outer piston part which serves as a carrier for the inner piston part and is connected to an engine shaft, and a piston actuator operably connected to the inner piston part wherein the inner piston part cycle is different from the outer piston part cycle, and wherein the piston actuator is configured to control the stroke length parameter of the inner piston part. The engine further comprising a variable valve timing system, comprising a first intake valve and a valve actuator, wherein the valve actuator is configured to selectively used to open or close an intake valve, a plurality of sensors, wherein the sensors collect data regarding the temperature and pressure of gasses flowing through an engine cylinder chamber, a variable compression ratio system, wherein the variable compression ratio system is configured to change the final compressed intake volume relative to an engine cylinder chamber when the piston is at top dead center of the compression stroke, and an electronic control unit operably connected to the variable stroke piston apparatus and variable valve timing system, wherein the electronic control unit is configured to control the stroke motion of a variable stroke piston, the operation of the variable valve timing system, and operation of the variable compression ratio system in response to data received from the plurality of sensors. In certain embodiments, the variable valve timing system further comprises a second valve actuator selectively used to open or close an exhaust valve.

Disclosed embodiments may further comprise a crankshaft wherein the ECU is configured to open and close an intake valve at least one time per revolution of the crankshaft, or a guide apparatus located outside of the cylinder, wherein the guide apparatus controls the operation of the inner piston part and/or a second intake valve which may be opened to allow airflow into the engine cylinder chamber and wherein the ECU is configured to operate the first intake valve and second intake valve independently of each other.

In certain embodiments, the piston actuator is configured to control the timing of the inner piston part, the piston actuator is an electromechanical actuator, the piston actuator is cam driven, the valve actuator is cam driven, and/or the valve actuator is an electromechanical actuator. In some embodiments, the electronic control unit controls the inner piston part in response to the operations of the variable valve timing system, the electronic control unit controls the inner piston part in response to the operations of the variable compression ratio system, and/or the electronic control unit is configured to stop the downward travel of the inner piston part substantially simultaneously with the closing of the intake valve

Certain embodiments further comprise a data recording system operably connected to the electronic control unit, wherein the electronic control unit is configured to analyze recorded engine performance data over time and adjust control of the inner piston part in response to the analyzed data.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

What is claimed is:

1) An internal combustion engine comprising:
a variable stroke piston apparatus, wherein the variable stroke piston apparatus comprises a variable stroke piston effective for reciprocal operation in an engine cylinder chamber, an inner piston part which closes and seals the cylinder chamber and an outer piston part which serves as a carrier for the inner piston part and is connected to an engine shaft, and a piston actuator operably connected to the inner piston part wherein the inner piston part cycle is different from the outer piston part cycle, and wherein the piston actuator is configured to control the stroke length parameter of the inner piston part;
a variable valve timing system, comprising a first intake valve and a valve actuator, wherein the valve actuator is configured to selectively used to open or close an intake valve;
a plurality of sensors, wherein the sensors collect data regarding the temperature and pressure of gasses flowing through an engine cylinder chamber; and
an electronic control unit operably connected to the variable stroke piston apparatus and variable valve timing system, wherein the electronic control unit is configured to control the stroke motion of a variable stroke piston and the operation of the variable valve timing system in response to data received from the plurality of sensors.

2) The internal combustion engine of claim 1, further comprising a variable compression ratio system, wherein the variable compression ratio system is configured to change the final compressed intake volume relative to an engine cylinder chamber when the piston is at top dead center of the compression stroke, wherein the electronic control unit is configured to control the variable compression ratio system in response to data received from the plurality of sensors.

3) The internal combustion engine of claim 1 wherein, the variable valve timing system further comprises a second valve actuator selectively used to open or close an exhaust valve.

4) The internal combustion engine of claim 1 further comprising a crankshaft wherein the electronic control unit is configured to open and close an intake valve at least one time per revolution of the crankshaft.

5) The internal combustion engine of claim 1 further comprising a guide apparatus located outside of the cylinder, wherein the guide apparatus controls the operation of the inner piston part.

6) The internal combustion engine of claim 1 wherein the piston actuator is configured to control the timing of the inner piston part.

7) The internal combustion engine of claim 1 wherein the piston actuator is an electromechanical actuator

8) The internal combustion engine of claim 1 wherein the piston actuator is cam driven.

9) The internal combustion engine of claim 1 wherein the valve actuator is cam driven.

10) The internal combustion engine of claim 1, wherein the valve actuator is an electromechanical actuator.

11) The internal combustion engine of claim 1, further comprising a second intake valve which may be opened to allow airflow into the engine cylinder chamber and wherein the electronic control unit is configured to operate the first intake valve and second intake valve independently of each other.

12) The internal combustion engine of claim 1, wherein the electronic control unit controls the inner piston part in response to the operations of the variable valve timing system.

13) The internal combustion engine of claim 2, wherein the electronic control unit controls the inner piston part in response to the operations of the variable compression ratio system.

14) The internal combustion engine of claim 1, wherein the electronic control unit is configured to stop the downward travel of the inner piston part substantially simultaneously with the closing of the intake valve.

15) The internal combustion engine of claim 1, wherein the electronic control unit is configured to stop the upward travel of the inner piston part substantially simultaneously with the closing of the exhaust valve.

16) The internal combustion engine of claim 1, further comprising a data recording system operably connected to the electronic control unit, wherein the electronic control unit is configured to analyze recorded engine performance data over time and adjust control of the inner piston part in response to the analyzed data.

17) An internal combustion engine comprising:
a variable stroke piston apparatus, wherein the variable stroke piston apparatus comprises a variable stroke piston effective for reciprocal operation in an engine cylinder chamber, an inner piston part which closes and seals the cylinder chamber and an outer piston part which serves as a carrier for the inner piston part and is connected to an engine shaft, and a piston actuator operably connected to the inner piston part wherein the inner piston part cycle is different from the outer piston part cycle, and wherein the piston actuator is configured to control the stroke length parameter of the inner piston part;
a variable valve timing system, comprising intake and exhaust valves and valve actuators, wherein the valve actuators are configured to selectively open or close intake valves, exhaust valves, or both;
a plurality of sensors, wherein the sensors collect data regarding the temperature and pressure of gasses flowing through an engine cylinder chamber;
a variable compression ratio system, wherein the variable compression ratio system is configured to change the final compressed intake volume relative to an initial compressed intake volume when the piston is at top dead center of the compression stroke; and
an electronic control unit operably connected to the variable stroke piston apparatus and variable valve timing system, wherein the electronic control unit is configured to control the stroke motion of a variable stroke piston, the operation of the variable valve timing system, and operation of the variable compression ratio system in response to data received from the plurality of sensors.

18) The internal combustion engine of claim 17, further comprising at least two cams, wherein each of the cams is configured to drive the piston actuator under different pre-defined load cases.

19) The internal combustion engine of claim 18, wherein the load cases are configured to optimize fuel efficiency under different defined driving conditions.

20) The internal combustion engine of claim 1, wherein the engine is used to operate an autonomous or connected vehicle.
